(19) United States
(12) Patent Application Publication
(10) Pub. No.: US 2004/0074364 A1
(43) Pub. Date: Apr. 22, 2004

(54) Multiple punch assembly

(75) Inventor: Andrew D. Prudhomme, Seneca Falls, NY (US)

Correspondence Address: PEARL TECHNOLOGIES, 13297 SENECA STREET, SAVANNA, NY, 13146, US

(73) Assignee: Pearl Technologies Inc.

(21) Appl. No.: 10/277,860

(22) Filed: Oct. 22, 2002

(51) Int. Cl. B26F 1/02

(52) U.S. Cl. 83/687; 83/698.91

(57) ABSTRACT

A multiple variable punch assembly is configurable for punching holes and slits in a plastic film material. The assembly has frame is positioned below the plane of film with one or more transverse carriages positioned to slide on the sides of the frame. Each of the carriages has side plate members, and upper and lower rails extending across the frame in the transverse direction. The upper rail is positioned above the plane of the film and the lower rail is positioned directly below the upper rail and below the film web plane. The positions of the carriages can be adjusted along the frame in the machine direction. The punch head assemblies are adjustably mounted the carriages, with an upper plate fitted onto the upper carriage rail and a lower backing plate situated beneath it on the lower carriage rail. An alignment pin can be inserted into aligned holes for positioning the upper plate and the lower backing plate. An auxiliary carriage can be mounted on one of the main carriages, and provides a pair of auxiliary rails for mounting an additional punch head.

### BACKGROUND OF THE INVENTION

The present invention relates to punches and apparatus for perforating film material such as polyethylene film or other films made of plastic resin. The invention is more particularly directed to apparatus for making multiple holes, cuts, and perforations in a web or sheet of a plastic film in a predetermined, adjustable pattern. The invention is specifically directed to an assembly which can be positioned along the path of travel of the web of film and can make all the required holes and perforations in the predetermined pattern at the same time, and which can be easily reconfigured for punching any number of holes and cuts in a different pattern.

Blades, punches, and cutters for forming holes and slits in plastic film material are described in prior U.S. Pat. Nos. 4,748,920 and 4,723,466 of Earl T. Pottorff. There, a self-sharpening hole punch formed of a low-friction, semi-rigid material, such as a polymer or a similar plastic resin. The hole punch has a thread at its upper end for screw-mounting onto reciprocating apparatus, which may be actuated by a pneumatic cylinder. Slit cutters are separately mounted on the reciprocating mechanism and spaced a small distance from the hole punch to create a gap in the film between the resulting hole and slit.

A so-called quick-slip punch adapter for a plastic bag making machine is described in U.S. Pat. Nos. 5,035,165 and 5,114,394. Typically, there are several of these on each bag machine. U.S. Pat. No. 6,148,710 concerns a slitter and hole punch and quick change adapter combination which fits a bag machine or similar equipment for punching holes and slits in a web of plastic film material. In that arrangement, a hole punch and a slitter blade are unitarily formed on a base member. Left and right resilient arms extend from distal to proximal, and have free ends that project proximally of the base member. The quick adapter can have a T-channel formed on a lower side to accommodate the replaceable hole punch and the slitter blade. The punches can be color coded for barrel diameter, gap size, etc. One possible combination of a slitter punch with a hold-down plate arrangement is described in U.S. patent application Ser. No. 09/713,392, commonly assigned and now pending. That arrangement clamps the film in place momentarily while the punch mechanism is fired, and then releases the film immediately thereafter. In some alternative designs, a spring is used to bias between the cutting head and the frame on which the hold-down plate is mounted. One spring-bias combination punch and hold-down clamp arrangement is disclosed in my earlier U.S. patent application Ser. No. 10/244,114, filed Sep. 16, 2002.

It is desired to provide a multiple punch mechanism in which the geometry of the pattern of holes, slits, and cuts can be adjusted in two dimensions, i.e., in the lengthwise or machine direction as well as the crosswise or transverse direction, and in which the shape and style of cutter can be changed. However, no such arrangement has been available on a single punch machine.

### OBJECTS AND SUMMARY OF THE INVENTION

Accordingly, it is an object of this invention to provide a multiple hole punch, which can be used for punching any desired number of holes, slits, cuts, and perforations in a single assembly and which avoids the drawbacks of the prior art.

It is another object of the invention to a multiple-head punch assembly in which the positions of the punch or cutting heads can be adjusted in the machine direction and in the transverse direction, and in which can be configured to accommodate various styles, shapes, and sizes of punches or cutters.

It is a further object to provide a multiple cutting head, multiple punch assembly in which a desired pattern of cuts, slits, and holes can be punched through the film as the film is drawn through the assembly, and in which the configuration of the various punches and cutting heads can be changed as needed.

According to one aspect of the present invention, a multiple punch assembly is provided for perforating a web of a plastic film material with the desired holes in a pattern, which is repeated as the film is drawn through the assembly. The plastic film material has a machine direction (or MD), which is the direction that the web moves past the punch assembly, and a transverse direction (or TD) which is the direction across the web of film. A frame is positioned below the plane at which the web of film passes in the machine direction, and the frame has first and second frame side members spaced from one another in the transverse direction. Each frame side member has a track member on its upper edge, oriented horizontally in the machine direction, and which serves to permit MD positioning of one or more moveable transverse carriages. In the disclosed embodiment, there are first and second carriages positioned atop the frame, with each of the carriages including left and right side plate member that are mounted on said frame side members and which can travel in the two tracks. That is, the side plate members of at least one of the first and second carriages is carried on the tracks of the frame side members, so as to be adjustable in the machine direction. Each carriage includes an upper rail and a lower rail extending across the frame, i.e., in the transverse direction, between its left and right side plate members. The upper rail is positioned above the plane of the film web and the lower rail is positioned directly below the upper rail and below the film web plane. One or both of the first and second carriages includes means permitting adjustment of the position of the carriage along the frame in the machine direction. The one or more punch head assemblies for creating the holes, slits, or other perforations are adjustably mounted on or more of the carriages. The punch head assembly includes an upper plate that is fitted onto the upper carriage rail and a lower backing plate that is situated beneath it on the lower carriage rail. The upper plate of the punch head assembly includes a cutting punch and an actuator, and the lower plate has a die opening that is aligned with the cutting punch. The punch head assembly also incorporates a mechanism for accurately positioning the upper plate and the lower backing plate in registered alignment in relation to one another, and can be embodied as an alignment pin that penetrates aligned openings of the upper and lower plates during set up.

To extend the capability of positioning additional punch head(s), an auxiliary carriage can be mounted on one of the main carriages discussed before. The auxiliary carriage includes an upper plate member that is slidably supported on the upper rail of one of the carriages and which extends in the machine direction above the film plane, and a lower plate member that is slidably supported on the lower rail of that carriage, and which extends in the machine direction parallel to said upper plate member and below the film plane. There are first and second rail members supported respectively on the upper and lower plate members, and these first and second rail members are oriented in the transverse direction, i.e., parallel to the carriage rails. An auxiliary punch head can be positioned on the rail members of the auxiliary carriage, with the auxiliary punch head having an upper member mounted on the first auxiliary rail member and a lower member mounted on the second auxiliary rail member. The auxiliary carriage further includes alignment pins or equivalent means for accurately positioning the upper plate member and the lower plate member in relation to one another, and means for accurately positioning the first and second auxiliary rail members in relation to one another.

In the preferred aspect of this invention, the track on each of the frame side members includes a toothed rack, and said the carriage includes a toothed wheel, e.g., spur gear or equivalent, engaging the rack for effecting adjustment of the position of the at least one carriage in the machine direction. The arrangement can include first and second toothed wheels on the left and right end plates of the carriage and engaging the tracks of the frame side members, a shaft extending in the transverse direction between said side plate members, a hand wheel for rotating the shaft, and means rotating the toothed wheels in synchronism with said shaft. A pair of air cylinders may be included as means for releasably locking the toothed wheels against rotation, so that the carriages are held in position on the frame.

In each of the punch heads, the punch head upper plate can include an air cylinder or equivalent reciprocating means that holds the cutting head in registered alignment with the film material and with a corresponding aperture in the lower die plate, with the reciprocating means moving the cutting head in a direction that is substantially normal to the lower die plate on which the web of film material is supported.

A clamp arrangement or hold-down clamp may be included as a part of the punch mechanism. Favorably, the hold-down clamp includes a clamping member situated above the lower backing plate and having an aperture aligned with the aperture(s) in the backing plate. The clamping member descends against said lower backing plate when said cutting head descends and lifts off the backing plate when said cutting head rises.

The punches can be slitter punches, which form a hole and a slit simultaneously, or they may be configured as slitters, perforators, multiple hole punches, or single hole punches, oval punches, or punches to create other geometrical shapes. Also, while terms of orientation, such as vertical, downward, left and right are used in respect to the embodiment described below, it should be appreciated that such terms are used for simplifying the description, and that the principles of this invention would be the same regardless of the positional orientation of the apparatus.

The above and many other objects, features, and advantages of this invention will become apparent from the ensuing description of an exemplary embodiment, which should be read in conjunction with the accompanying Drawing.

### BRIEF DESCRIPTION OF THE DRAWING

FIG. 1 is a perspective view of a multiple punch arrangement according to one preferred embodiment of the invention.

FIG. 2 is a top plan view showing a web of film passing through the multiple punch arrangement of this invention.

FIG. 3 is perspective view of the frame of this embodiment.

FIG. 4 is an assembly view of one of the main carriages of this embodiment.

FIG. 5 is a perspective view of one cutting head employed in this embodiment.

FIG. 6 is an exploded assembly view of the cutting head of FIG. 5.

FIG. 7 is a perspective view of an auxiliary carriage employed in this embodiment.

FIG. 8 is an exploded assembly view of the auxiliary carriage of FIG. 7.

### DETAILED DESCRIPTION OF THE PREFERRED EMBODIMENTS

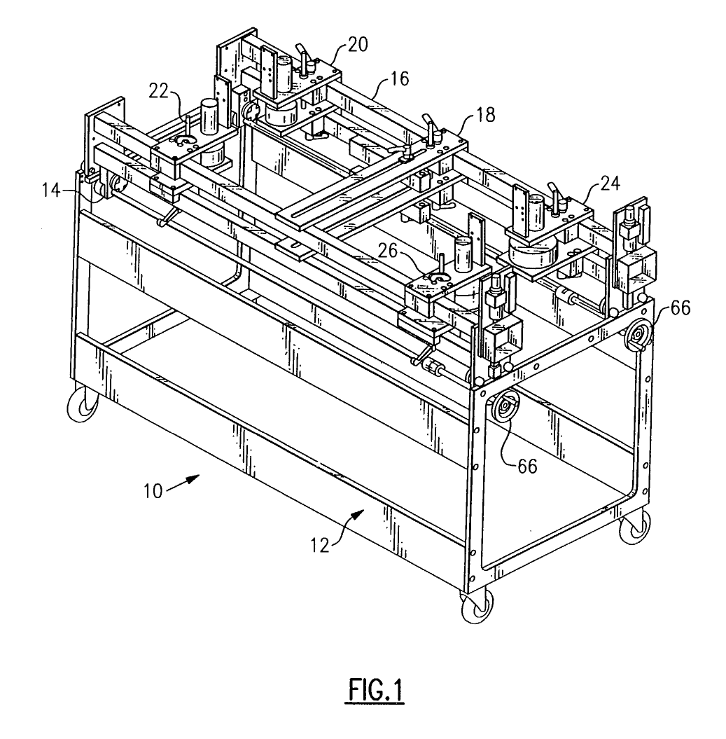

With reference to the Drawing, FIG. 1 illustrates a multiple punch assembly 10 according to one preferred embodiment of this invention. This assembly 10 is a component system, and is modularized so that more or fewer punch heads can be used, depending on the particular application, and in which the various punch heads can be switched and valved from a central location to be turned on and off individually. The positions of the heads can be adjusted in the machine direction, i.e., along the travel direction of the film, as well as in the transverse direction, i.e., across the film. This multiple punch assembly can constitute one operative portion of a bag machine or similar plastic film processing apparatus, and serves for forming holes and/or slits in a web of plastic film that passes through it.

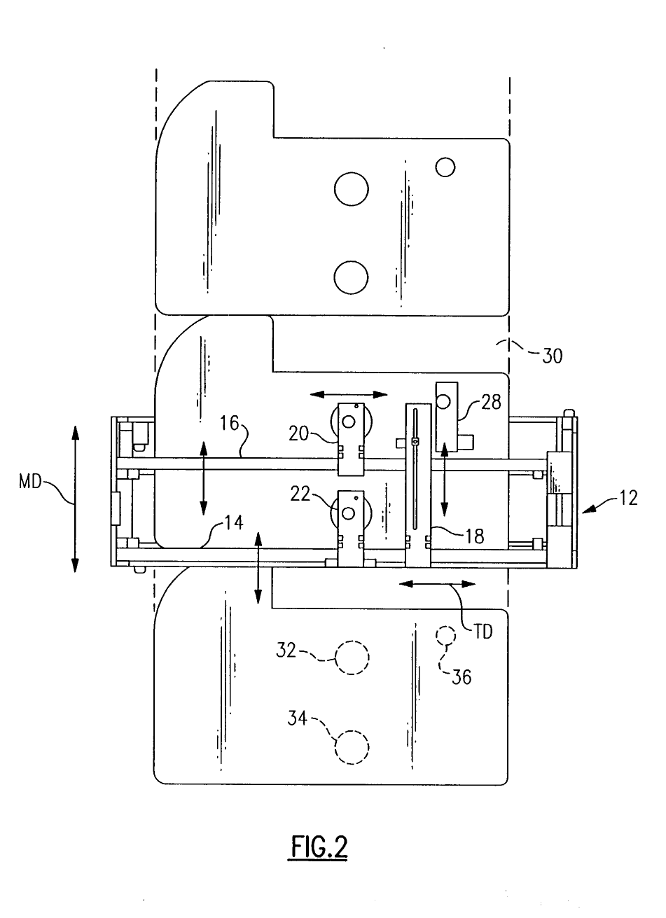

The multiple punch assembly 10 has a frame 12 that can be rolled or otherwise moved into position along the direction of travel of the film web, with first and second main carriages 14 and 16 extending across the frame 12 in the transverse direction or TD, and an auxiliary carriage 18 is mounted onto one or the other of the main carriages 14, 16. As shown here, there are four punch heads 20, 22, 24, and 26 supported on the main carriages. An optional auxiliary punch head 28 (omitted in FIG. 1 but illustrated in FIG. 2) can be mounted on the auxiliary carriage.

As illustrated in FIG. 2, a web of film 30, e.g., polyethylene bag material, has its long direction of machine direction oriented in a direction of travel that passes through the punch heads of the multiple punch assembly 10. Some of the punches may be enabled or switched on to produce the cuts and openings needed for the article being formed on the film web 30. In this case there are holes 32, 34, and 36 being punched or cut by the punch heads 20, 22, and 28. The ghost-line circles in FIG. 2 are intended to indicate the positions of the holes in the film before the film 30 is advanced into the assembly 10, while the full-line circles indicate the holes 32, 34, 36 cut into the film, with the film having advanced to the next position. The arrows illustrate the machine direction MD, or long dimension of the web of film 30, as well as the transverse direction TD, or the direction across the web of film.

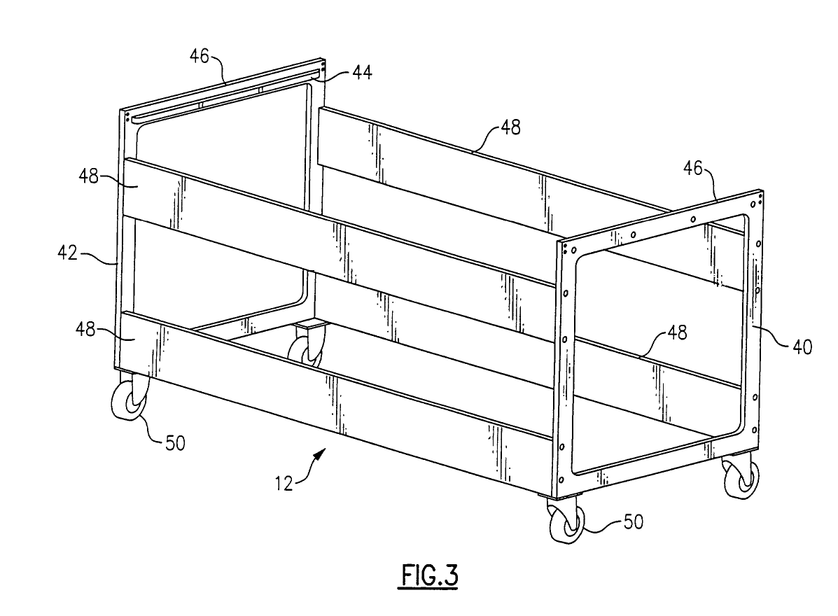

The frame 12 is illustrated in FIG. 3, and is explained here in detail. The frame 12 has left and right frame sides 40 and 42, each of which has a flat top edge 46, and a gear rack 44 that is disposed at an inward face of the frame side and disposed horizontally a short distance below the top edge. Frame rails 48 extend across the frame in the transverse direction, and join the frame sides 40, 42. In this embodiment, there are four frame rails 48, disposed two in front and two in back, with one of each pair above the other. At the bottom corners of the frame 12 there are four lockable casters 50. The casters 50 allow the entire frame to be positioned as needed in respect to other film processing equipment, such that the web of film travels through the carriages and punches that are positioned above the frame 12.

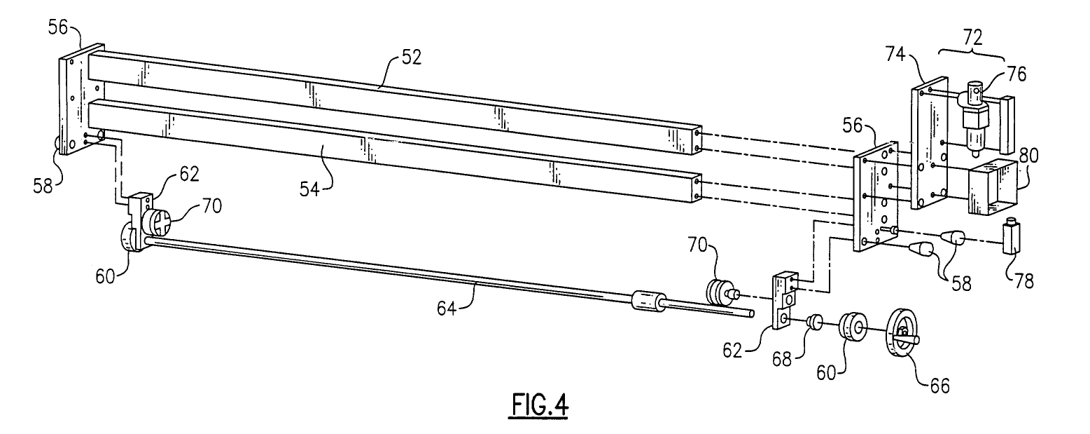

The two carriages 16 and 18 of this embodiment are constructed as illustrated in FIG. 4, with each carriage 16 (18) having an upper rail 52 and a lower rail 54, which extend in the transverse directions and are mounted one above the other on respective left and right side plates 56. The plane of the film web 30 will lie in the space between the upper rail 52 and the lower rail 54. On each of the side plates 56 there is a pair of cam rollers 58, which are adapted to rest upon the top edges 46 of the frame sides 40, 42 and can roll to permit movement of the carriage 16 or 18 in the machine direction. A pair of spur gears 60 are associated with the two side plates 56 and are adapted to mesh with the respective gear racks 44. A pair of mounts 62 attached at the lower part of the side plates 46 journal a shaft 64, on which the spur gears 60 are mounted. A hand wheel 66 or crank is also mounted on the shaft on one end, and allows the technician to set up the multiple punch assembly by moving the carriage 16 or 18 to a desired position. There are bearings 68 for journalling the shaft 64 in the mounts 62, and a pair of air cylinders 70 that are actuated to lock the spur gears 60 against rotation to lock the carriage in place in the machine direction.

Also shown in FIG. 4 are an air cylinder control assembly 72, including a mounting plate 74 that is fastened onto one of the side plates 56. This assembly includes an air regulator 76 and a valve 78 situated in a control box 80, for supplying air to the cylinders 70. Air hoses are omitted in these views.

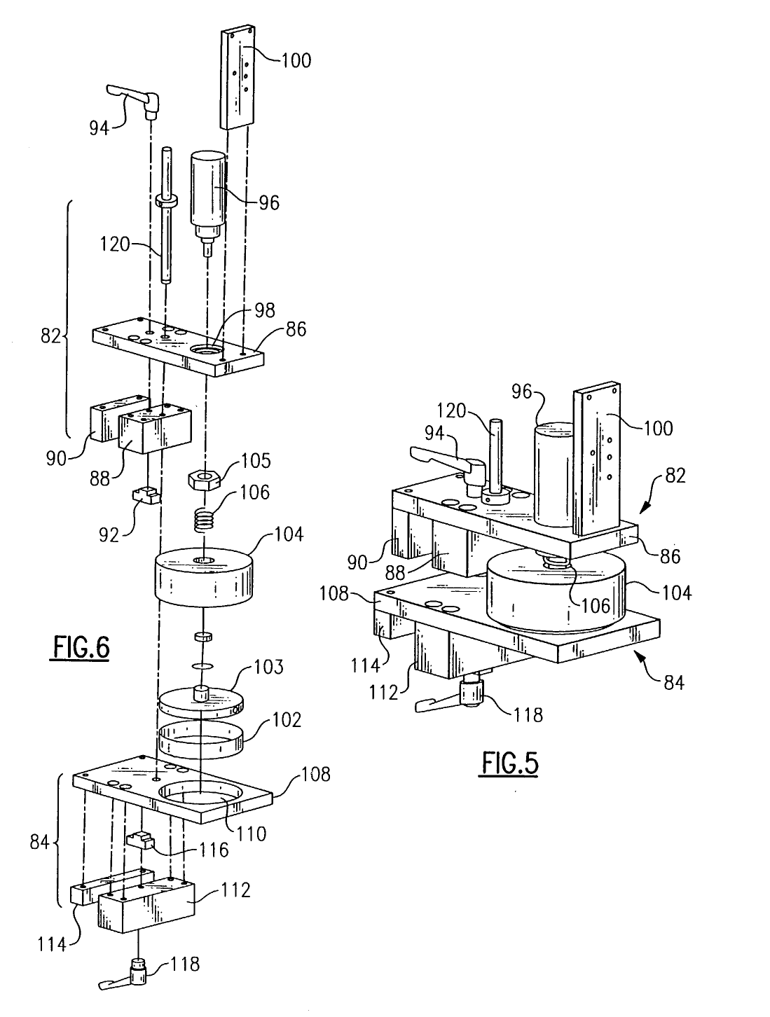

An example of one of the punch heads 20 employed in this embodiment is illustrated in FIGS. 5 and 6. The head 20 is typical, and the other punch heads 22, 24, 26, 28 can be of a similar construction. The cutting head or blade itself can vary in size and shape, depending on the type of cut, perforation, or hole that is needed.

Here the punch head is comprised of an upper or cutting member 82 and a lower or backing member 84, which are supported respectively on the upper and lower transverse rails 52, 54 of one of the carriages.

The upper or cutting member 82 has a horizontally disposed cylinder plate 86, and a metal block or body 88 mounted on its under side. Another metal block or hook 90 is situated at the end of the plate 86 such that the hook 90 and body 88 define between them a transverse channel, i.e. a recess extending in the TD, that fits onto the respective upper rail 52 of the associated carriage. A clamp 92 and an associated clamp lever 94 permit the technician to lock the upper member 82 in position on the rail once the correct position has been established.

The cylinder plate 86 carries an air cylinder 96, which may be a double-action air cylinder, as discussed in my copending application Ser. No. 10/244,114, which mounts in an opening 98 in the plate 86. A valve mounting plate 100 supports an air valve (not shown) and other associated pneumatic hardware for supplying air to the cylinder 96.

A cutting blade 102 is mounted onto a rod of the cylinder 96, and in this case the blade 102 is circular for cutting or punching a circular hole 32. In this case, the blade 102 is a separate member from its blade mount 103, but a unitary punch or blade could as easily be used here. A hold-down clamp 104 is disposed over the punch blade, and can be configured in the fashion discussed in my copending application Ser. No. 10/244,114. A jam nut 105 is disposed over the cylinder rod below the plate 86, and a coil compression spring 106 is held between an upper end of the clamp 104 and the jam nut 105.

The lower or backing member 84 of the punch head has a horizontal die plate 108, in which there is an aperture 110 to allow the blade 102 to pass through during a punching operation while the backing or die plate 108 is supporting the web of film 30. The backing member has a body 112 and claw 114, situated in a fashion similar to the corresponding members on the upper punch member 82, and the body 112 and claw 114 define between them a TD channel that fits over the lower rail member 54 of the carriage. A clamp 116 and clamp lever 118 permit the technician to secure the lower member 84 in place after it has been properly aligned and positioned together with the upper member 82.

An alignment pin 120 is shown here residing in a pair of vertically aligned openings in the upper and lower punch members 82 and 84. This pin 120 has a collar that is offset to one side so that it has a long end and a short end. During set-up, the pin is oriented with the long side down, and the pin ensures that the upper and lower members 82 and 84 are in alignment. Then, the clamp levers 94 and 118 are turned to secure the aligned punch head members in place on the upper and lower rails 52, 54. The pin 120 is then inverted into a storage position, with the long end upwards and the short end down, so that the pin no longer penetrates the space between the that the upper and lower portions of the punch head, and does not interfere with passage of the web of film 30.

It should be appreciated that the alignment pin 120 is one of many possible ways of achieving alignment of the two halves of the punch head. Alignment could also be accomplished using optical, opto-electrical (e.g., laser), mechanical, or electro-mechanical means.

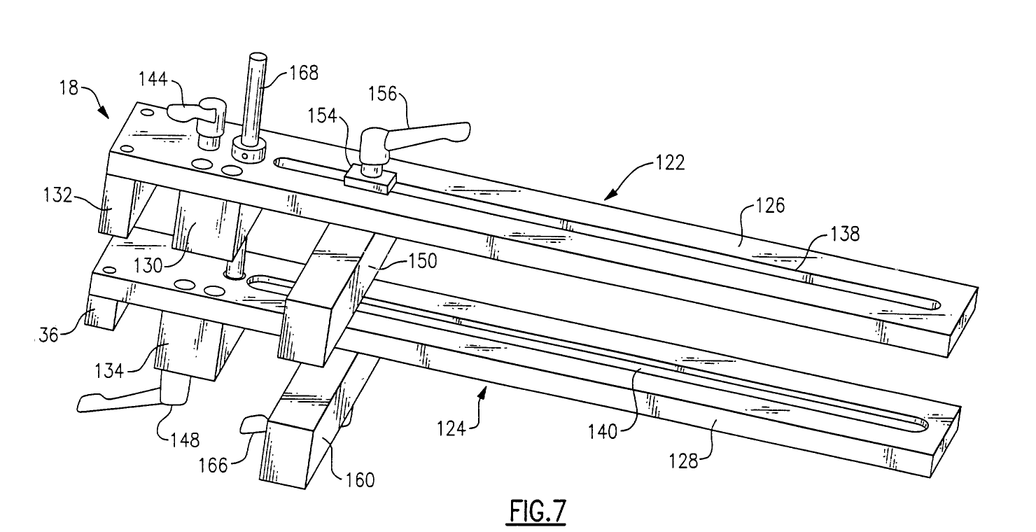

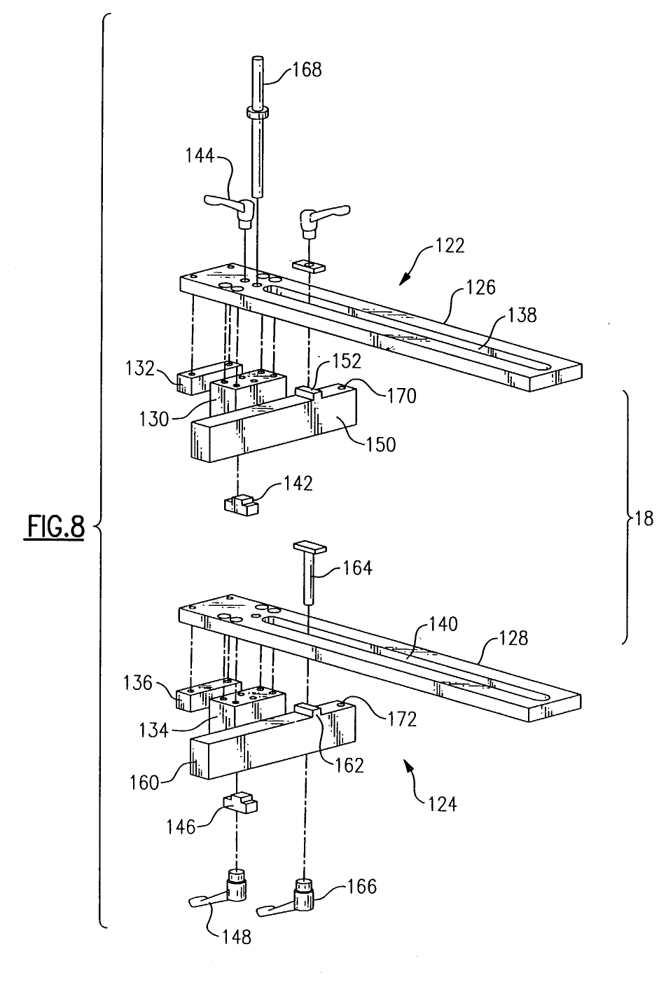

The auxiliary carriage 18 can be constructed as generally illustrated in FIGS. 7 and 8. The auxiliary carriage is comprised of an upper member 122 and a lower member 124, situated one above the other on the upper and lower rails 52, 54, respectively, of one of the main carriages 16 or 18. The upper member has an auxiliary plate 126 that extends in the machine direction, with a body 130 and hook 132 at its underside that form a transverse channel for mounting on the upper rail 52. The plate 126 has a slot 138 that extends in the machine direction. The lower member also comprises an auxiliary plate 128 that is oriented in the machine direction, with a body 134 and a hood 136 that define a transverse channel for mounting onto the rail 54. The lower auxiliary plate 128 also has a machine-direction slot 140. A clamp 142 and lever 144 secure the upper member 122 in position along the rail 52, and a clamp 146 and lever 148 secure the lower member 124 in position on the lower rail 54.

The upper member 122 also has an upper auxiliary rail 150, with a ridge 152 that seats slideably into the MD slot 138, and there is a clamp 154 and clamp lever 156 to secure this rail 150 in position on the clamp plate 126. The auxiliary rail 150 is thus oriented in the transverse direction. Similarly, the lower member 124 has a lower auxiliary rail 160, which has a ridge 162 that seats slidably into the slot 140 in the lower auxiliary plate 128, and a clamp 164 and clamp lever 166 secure the auxiliary rail 150 in position on the auxiliary plate 128. A locating or positioning pin 168 is used for positioning the two auxiliary plates 126 and 128 in alignment, one above the other. This pin can also be used in alignment holes 170 and 172 in the auxiliary rails 150, 160 to align the two auxiliary rails so one is directly above the other.

As also shown in FIGS. 3 and 4, there is a tab or flange 57 that extends back from the

There are many equivalents to the foregoing preferred embodiment, which may be employed depending on the manufacturing requirement. For example, the double action actuators, which are represented here as air cylinders, could be a hydraulic cylinder, or an electromagnetic or electromechanical actuator. Also, the compression spring could be a leaf spring or other known spring, depending on the design of the bag machine. It is also possible for the multiple punch assembly 10 to have three or more carriages rather than only the two main carriages 16, 18 of this embodiment, or that one of the carriages may be fixed in its position on the frame 12, with the other carriage(s) being movable. It is possible for one or more of the punch heads 20, 22, 24, 26, etc., to be inactive for a given punch set up, but remain in place on the main or auxiliary carriage.

While this invention has been described in detail with reference to a selected preferred embodiments, it should be recognized that the invention is not limited to those embodiments. Rather, many modifications and variations will present themselves to persons skilled in the art without departing from the scope and spirit of the invention, as defined in the appended claims.

I claim:

1. A multiple punch assembly for perforating a web of a plastic film material, said plastic film material having a machine direction in which the web moves past the punch assembly and a transverse direction; the punch assembly comprising
a frame positioned below a plane at which said web of film passes in the machine direction, said frame having first and second frame side members spaced from one another in the transverse direction, each said frame side member having a track member thereon that is oriented in the machine direction;
first and second carriages positioned on said frame and each of said carriages including left and right side plate member that are mounted on said frame side members, with the side plate members of at least one of the first and second carriages being adjustably carried on the tracks of the frame side members, and each carriage also including an upper rail and a lower rail extending in the transverse direction between its respective left and right side plate members, with the upper rail being positioned above the plane of said film web and the lower rail being positioned directly below the upper rail and below said plane; and said at least one of said first and second carriages including means permitting adjustment of the position of the carriage along the frame in the machine direction; and
at least one punch head assembly that is movably mounted on one of said first and second carriages; said punch head assembly including an upper plate that is adjustably mounted on the upper rail thereof and a lower backing plate that is mounted on the lower rail thereof, said upper plate including a cutting punch and an actuator therefor, and the lower plate including a die opening that is aligned with said cutting punch, said punch head assembly further including means for accurately positioning the upper plate and the lower backing plate in relation to one another.

2. The multiple punch assembly according to claim 1, further comprising an auxiliary carriage which includes an upper plate member that is slidably supported on the upper rail of one of said carriages and which extends in the machine direction above said film plane; a lower plate member that is slidably supported on the lower rail of one of said carriages, and which extends in the machine direction parallel to said upper plate member and below said film plane; and first and second rail members supported respectively on said upper and lower plate members, the first and second rail members being oriented in the transverse direction; and an auxiliary punch head that has an upper member that is mounted on the first rail member and a lower member that is mounted on the second rail member.

3. The multiple punch assembly according to claim 2, the auxiliary carriage further including means for accurately positioning the upper plate member and the lower plate member in relation to one another, and means for accurately positioning the first and second rail members in relation to one another.

4. The multiple punch assembly according to claim 3, with said means for accurately positioning the upper and lower plate members including a pin that is positioned in respective aligned apertures in the upper and lower plate members during alignment, and which is removable after alignment.

5. The multiple punch assembly according to claim 1, wherein said means for accurately positioning the upper plate and lower backing plate in relation to one another includes a pin that is positioned in respective aligned apertures in the upper and lower backing plates during alignment, and which is removable after alignment.

6. The multiple punch assembly according to claim 1 wherein said track on each of said frame side members includes a toothed rack; and said means permitting adjustment of the position of the at least one carriage along the frame in the machine direction includes first and second toothed wheels on the left and right end plates of said at least one carriage and engaging the tracks of the frame side members, an elongated shaft extending in the transverse direction between said side plate members, a hand wheel for rotatably driving said shaft, and means rotating said toothed wheels in synchronism with said shaft.

7. The multiple punch assembly according to claim 6 wherein said means permitting adjustment further includes means for releasably locking said toothed wheels against rotation.

8. The multiple punch assembly according to claim 1 wherein said punch head upper plate includes reciprocating means for holding the cutting head in alignment with said film material and with a corresponding aperture in said lower die plate, and for moving the cutting head in a direction that is substantially normal to said lower die plate on which the web of film material is supported, and a hold-down clamp including a clamping member situated above said lower backing plate and having at least one aperture therein in alignment with one or more corresponding apertures in the backing plate and through which said cutting head passes when said hold-down clamp is biased against the film material on said lower backing plate; with said reciprocating means acting to urge said clamping member against said lower backing plate when said cutting head descends and acting to lift said clamping plate off said backing plate when said cutting head rises.

9. The multiple punch assembly according to claim 8, wherein there is at least one punch head supported on each of said first and second carriages and on said auxiliary carriage.

10. The multiple punch assembly according to claim 1, wherein each said punch head has a clamp on its upper plate that secures the upper plate at a selected location on the upper rail of the respective carriage, and a clamp on its lower backing plate that secures the latter at a selected location on the lower rail of the respective carriage, with each of said clamps having a lock means that can be actuated to lock the plate in place on the rail and released to permit the plate to move along the rail.

11. A multiple variable position punch assembly for cutting perforations and/or holes at predetermined positions in a web of plastic film that is drawn through the assembly along a horizontal plane, the film web having a machine direction along the direction of movement of the film web and a transverse direction that extends across the web; the assembly comprising:
a frame which includes left and right side members separated from one another in the transverse direction, said frame side members each having a horizontal track formed thereon oriented in the machine direction;
at least one carriage which includes an upper rail and a lower rail that extend across the frame in the transverse direction with the upper rail being positioned directly over the lower rail, first and second side plates supporting the upper and lower rails, and each having means traveling in a respective track of said frame side members, and means for adjustably selecting the position of the carriage in the machine direction relative to said frame; and
at least one punch head supported on said carriage, and having an upper member adjustably mounted on said upper rail and a lower member adjustably supported beneath it on said lower rail; said upper member including an actuator supporting a cutting head; and said lower member including a backing plate having a die opening aligned with said cutting blade; with the plane of the film web being between the upper and lower members of the cutting head; and means adapted to be placed through alignment openings in the upper and lower members for aligning the upper and lower members of the cutting head.

12. The multiple variable position punch assembly according to claim 11, wherein there are a first and a second of said carriages.

13. The multiple variable position punch assembly according to claim 11, further comprising an auxiliary carriage that is adjustably mounted on said at least one carriage for supporting an auxiliary cutting head.

14. The multiple variable position punch assembly according to claim 11, wherein said auxiliary carriage includes a first horizontal plate extending in the machine direction from an upper rail of said carriage, and an upper auxiliary rail that is adjustably positioned along said first horizontal plate and extending in the transverse direction; and a second horizontal plate extending in the machine direction from the lower rail of said carriage, and a second auxiliary rail that is adjustably positioned on the second horizontal plate and extending in the machine direction below the upper auxiliary rail.

15. The multiple variable position punch assembly according to claim 14, wherein said auxiliary carriage includes means adapted to be placed through alignment openings in the first and second horizontal plates for aligning the horizontal plates of the auxiliary carriage.

16. The multiple variable position punch assembly according to claim 14, wherein said auxiliary carriage includes means adapted to be placed through alignment openings in the upper and lower auxiliary rails for aligning the upper and lower rails.

17. The multiple variable position punch assembly according to claim 11, wherein each said track includes a top edge of the respective frame side member and said means traveling in the respective track of the frame side member includes a plurality of rollers disposed on the side plates of said carriage.

18. The multiple variable position punch assembly according to claim 11, wherein each said track includes a toothed rack extending in the machine direction on the respective frame side member, and said means for adjustably selecting the position of the carriage in the machine direction includes a shaft extending in the transverse direction between said side plates, a pair of toothed wheels respectively engaging the toothed tracks on the frame side members, and a crank member for manually rotating said shaft and said toothed wheels to adjust the position of said carriage in the machine direction.

19. The multiple variable position punch assembly according to claim 17, wherein said means for adjustably selecting the position of the carriage further includes actuable cylinders for selectively locking said toothed wheels against rotation.
